(19) United States
(12) Patent Application Publication
(10) Pub. No.: US 2018/0145401 A1
(43) Pub. Date: May 24, 2018

(54) Wireless Determination of Surface Wear

(71) Applicant: Motorola Mobility LLC, Chicago, IL (US)

(72) Inventors: Scott DeBates, Chicago, IL (US); Douglas Lautner, Chicago, IL (US); Jagatkumar Shah, Chicago, IL (US); Mary Hor-Lao, Chicago, IL (US)

(73) Assignee: Motorola Mobility LLC, Chicago, IL (US)

(21) Appl. No.: 15/358,535

(22) Filed: Nov. 22, 2016

(51) Int. Cl. H01Q 1/27; H01Q 1/22

(52) U.S. Cl. CPC H01Q 1/273; H01Q 1/2291; H01Q 1/2208

(57) ABSTRACT

Systems and methods for monitoring wear of a wearable component use an RFID antenna embedded in the wearable component to indicate whether wear has reached a predetermined limit. A monitoring device includes an RF transceiver, an RF antenna linked to the RF transceiver, and a processor configured to emit an RF probe signal from the RF antenna via the RF transceiver, and to determine whether the wearable component has worn beyond the predetermined limit based on whether a responsive RFID signal is received from the embedded RFID antenna.

### TECHNICAL FIELD

The present disclosure is related generally to wireless communication technologies, and, more particularly, to a system and method for wirelessly determining wear in an item.

### BACKGROUND

While most devices and products are intended to be relatively permanent, some products are wearable or consumable by their very nature. Such products include tires, shoe soles, power transmission belts, and so on. The requirement that these products provide a high-friction grip also results in unavoidable wear of the friction surface over time. Other consumable products and devices may use their inherent strength rather than their frictional properties for operation, and may fail suddenly rather than gradually. Such devices include straps, e.g., for hoisting and transportation, cords, e.g., as part of a multi-strand structural component in a parachute system, and so on.

In either case, the failure of a component may precede a much more significant failure. For example, a worn tire may not yet have ruptured but may be nearing total failure, and a worn pair of shoes may lack traction without yet having allowed entry of water into the shoe through the sole. In a more ominous context, a single ruptured structural cord may not yet have compromised the integrity of the supported structure as a whole. However, it is sometimes difficult to detect the failure of such components prior to significant damage, inconvenience, or even danger.

Before proceeding, it should be appreciated that the present disclosure is directed to a system that can eliminate some of the shortcomings noted in this Background section. However, any such benefit is not a limitation on the scope of the disclosed principles, or of the attached claims, except to the extent expressly noted in the claims. Additionally, the discussion of technology in this Background section is reflective of the inventors' own observations, considerations, and thoughts, and is in no way intended to accurately catalog or comprehensively summarize any prior art reference or practice. As such, the inventors expressly disclaim this section as admitted or assumed prior art. Moreover, the identification herein of desirable courses of action reflects the inventors' own observations and ideas, and should not be assumed to indicate an art-recognized desirability.

### BACKGROUND

In an embodiment of the disclosed principles, method is provided for monitoring wear of a wearable surface or component. The method includes emitting a near field radio frequency (RF) signal directed to an antenna embedded in the surface, and determining whether a responsive radio frequency transmission is received from the antenna. The wearable surface is identified as worn if a responsive radio frequency transmission has not been received from the antenna.

In another aspect of the disclosed principles, a system is disclosed for monitoring wear of a wearable component. The system includes an antenna system embedded in the wearable component such that wear of the wearable component beyond a predetermined limit will cause damage to the antenna system, and a monitoring device including an RF transmitter and a processor. The processor is configured to emit an RF probe signal receivable by the antenna system, determine whether a responsive RF signal has been received from the antenna system and identify the wearable component as worn beyond the predetermined limit if a responsive RF signal has not been received from the antenna system.

In yet another embodiment of the disclosed principles, device is provided for monitoring wear of a wearable component having embedded therein an RFID antenna. The device includes an RF transceiver, an RF antenna linked to the RF transceiver, and a processor configured to emit an RF probe signal from the RF antenna via the RF transceiver, and to determine whether the wearable component has worn beyond a predetermined limit based on whether a responsive RFID signal is received from the embedded RFID antenna.

Other features and aspects of the disclosed principles will be apparent from the detailed description taken in conjunction with the included figures, of which:

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a simplified schematic of an example device with respect to which embodiments of the presently disclosed principles may be implemented;

FIG. 2 is a device-level schematic showing an operating environment in accordance with an embodiment of the disclosed principles;

FIG. 3 is a device-level schematic showing an alternative operating environment in accordance with an embodiment of the disclosed principles;

FIG. 4 is a flowchart of a process for gathering and interpreting RFID data in the context of monitoring a consumable surface in accordance with an embodiment of the disclosed principles; and

FIG. 5 is circuit diagram of an RFID tag antenna architecture usable in accordance with an embodiment of the disclosed principles.

### DETAILED DESCRIPTION

Before presenting a detailed discussion of embodiments of the disclosed principles, an overview of certain embodiments is given to aid the reader in understanding the later discussion. As noted above, the failure of wearable or consumable items may cause inconvenience or damage if not quickly detected and remedied. Similarly, the failure of one or more parts responsible for safety or load-sharing may create a situation wherein rapid detection of the failure and replacement of the part is needed in order to return the capacity or safety level of the assembly back to its original state. However, it is sometimes difficult to detect the excess wear or outright failure of consumable or critical components in time to prevent further damage or inconvenience.

In one aspect of the disclosed principles, a wearable or critical element has embedded therein a radio frequency identification (RFID) antenna or other near-field communication (NFC) antenna. Disruption of the element via failure or excess wear is detected by the failure of the antenna. In a further aspect, the antenna is reactive rather than being powered. In a further embodiment, two or more such antennas are used in a single component, and yet a further aspect, multiple related components may each be equipped with one or such antennas.

The antennas are monitored either centrally or by a dispersed sensor network. Monitoring may be executed by the transmission of periodic electromagnetic frequency (EMF) probes and the receipt of a reradiated signal in response. In this context, the failure of any antenna is detected by its failure to return a reradiated signal for example.

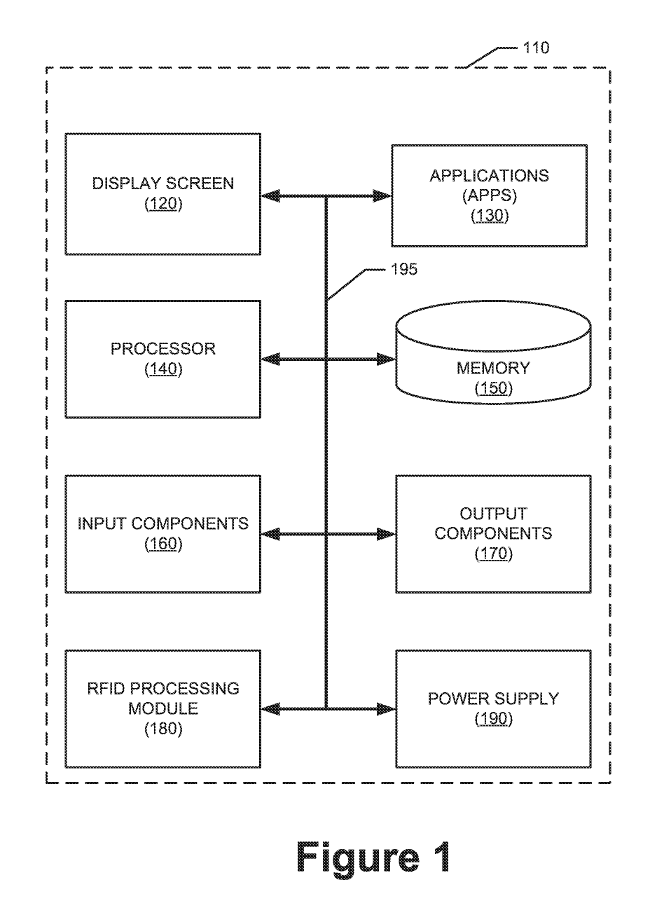

With this overview in mind, and turning now to a more detailed discussion in conjunction with the attached figures, the techniques of the present disclosure are illustrated as being implemented in a suitable computing environment. The following generalized device description is based on embodiments and examples within which the disclosed principles may be implemented, and should not be taken as limiting the claims with regard to alternative embodiments that are not explicitly described herein. Thus, for example, while FIG. 1 illustrates an example mobile device with which embodiments of the disclosed principles may be implemented, it will be appreciated that other device types may be used, including but not limited to laptop computers, tablet computers, embedded automobile computing systems and so on.

The schematic diagram of FIG. 1 shows an exemplary device 110 forming part of an environment within which aspects of the present disclosure may be implemented. In particular, the schematic diagram illustrates a user device 110 including several exemplary components. It will be appreciated that additional or alternative components may be used in a given implementation depending upon user preference, component availability, price point and other considerations.

In the illustrated embodiment, the components of the user device 110 include a display screen 120, applications (e.g., programs) 130, a processor 140, a memory 150, one or more input components 160 such as RF input facilities, and one or more output components 170 such as RF output facilities. It will be appreciated that a single transceiver and antenna may serve as both the output antenna and the receiving antenna.

The processor 140 can be any of a microprocessor, microcomputer, application-specific integrated circuit, or the like. For example, the processor 140 can be implemented by one or more microprocessors or controllers from any desired family or manufacturer. Similarly, the memory 150 may reside on the same integrated circuit as the processor 140. Additionally or alternatively, the memory 150 may be accessed via a network, e.g., via cloud-based storage. The memory 150 may include a random access memory (i.e., Synchronous Dynamic Random Access Memory (SDRAM), Dynamic Random Access Memory (DRAM), RAMBUS Dynamic Random Access Memory (RDRM) or any other type of random access memory device or system). Additionally or alternatively, the memory 150 may include a read only memory (i.e., a hard drive, flash memory or any other desired type of memory device).

The information that is stored by the memory 150 can include program code associated with one or more operating systems or applications as well as informational data, e.g., program parameters, process data, etc. The operating system and applications are typically implemented via executable instructions stored in a non-transitory computer readable medium (e.g., memory 150) to control basic functions of the electronic device 110. Such functions may include, for example, interaction among various internal components and storage and retrieval of applications and data to and from the memory 150.

Further with respect to the applications, these typically utilize the operating system to provide more specific functionality, such as file system service and handling of protected and unprotected data stored in the memory 150. Although many applications may provide standard or required functionality of the user device 110, in other cases applications provide optional or specialized functionality, and may be supplied by third party vendors or the device manufacturer.

With respect to informational data, e.g., program parameters and process data, this non-executable information can be referenced, manipulated, or written by the operating system or an application. Such informational data can include, for example, data that are preprogrammed into the device during manufacture, data that are created by the device or added by the user, or any of a variety of types of information that are uploaded to, downloaded from, or otherwise accessed at servers or other devices with which the device is in communication during its ongoing operation.

Although not shown in detail in FIG. 1, the device 110 includes an RFID processing module 180 to control the sending and receipt of RFID signals for example, and to process the results. In an embodiment, a power supply 190, such as a battery or fuel cell, is included for providing power to the device 110 and its components. All or some of the internal components communicate with one another by way of one or more shared or dedicated internal communication links 195, such as an internal bus.

In an embodiment, the device 110 is programmed such that the processor 140 and memory 150 interact with the other components of the device 110 to perform a variety of functions. The processor 140 may include or implement various modules (e.g., the RFID processing module 180) and execute programs for initiating different activities such as launching an application, transferring data and toggling through various graphical user interface objects (e.g., toggling through various display icons that are linked to executable applications).

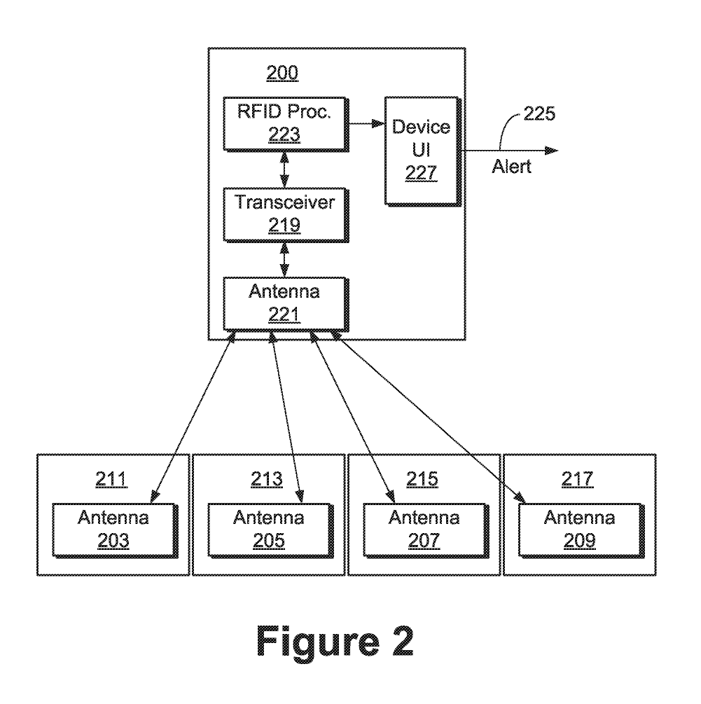

Turning to FIG. 2, this figure provides a device-level schematic showing an operating environment in accordance with an embodiment of the disclosed principles. As can be seen, a monitoring device 201, e.g., a device such as the device 110 shown in FIG. 1, is wirelessly associated with a plurality of embedded RFID antennas 203, 205, 207, 209. Each of the embedded RFID antennas 203, 205, 207, 209 is associated with a respective consumable item 211, 213, 215, 217. The consumable items 211, 213, 215, 217 may be tires, belts, strands of cable or cord and so on.

In operation, a transceiver 219 of the monitoring device 201, using an antenna 221, transmits a periodic EMF pulse, coded or otherwise, of sufficient strength to activate the embedded RFID antennas 203, 205, 207, 209. These embedded RFID antennas 203, 205, 207, 209 in turn emit a characteristic EMF transmission of sufficient strength to be received by the antenna 221 and interpreted by a transceiver 219.

In accordance with an aspect of the disclosed principles, the embedded RFID antennas 203, 205, 207, 209 are located within their respective consumable items 211, 213, 215, 217 in a manner such that when a consumable item 211, 213, 215, 217 wears to a certain level or fails, the associated embedded RFID antenna 203, 205, 207, 209 fails, e.g., via separation of an antenna trace of the antenna

If one or more of the embedded RFID antennas 203, 205, 207, 209 are disabled in this manner, the transceiver 219 does not receive a characteristic response from the one or more disabled antennas. An RFID processing module 223 of the monitoring device 201 will then interpret the received data to indicate that consumable items associated with the disabled antennas are worn or have experienced failure and should be repaired or replaced. The RFID processing module 223 may cause a corresponding alert 225 to be displayed or emitted to a user by the user interface (UI) 227 of the monitoring device 201.

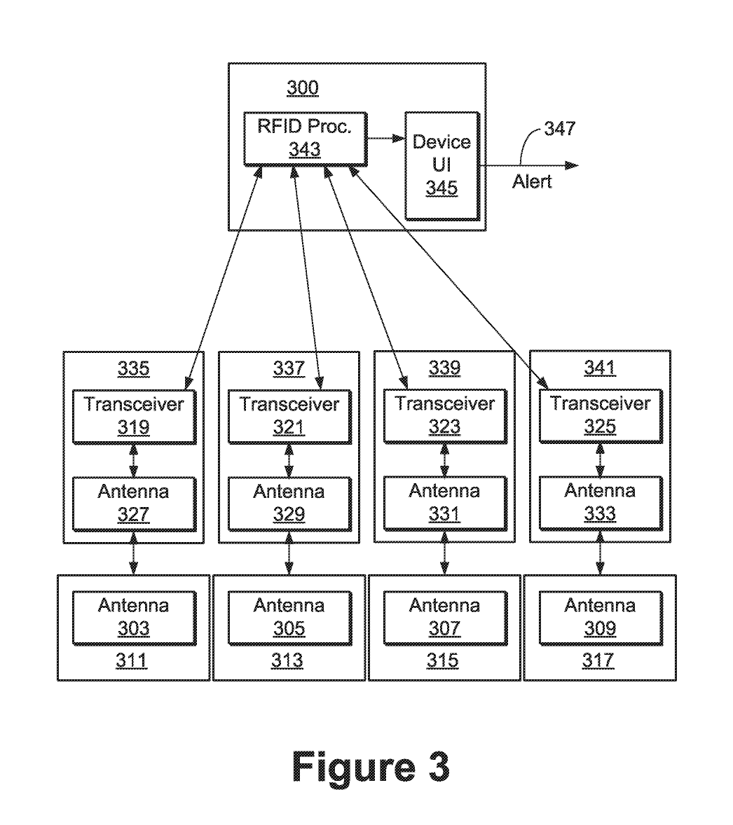

In an alternative embodiment consistent with the disclosed principles, the monitoring of the embedded antennas may instead be distributed as shown in FIG. 3. This embodiment may be beneficial in contexts wherein the items to be monitored are too far apart to enable RFID communications of all antennas with a single central device.

In this alternative embodiment, each consumable item 311, 313, 315, 317 includes a respective embedded RFID antenna 303, 305, 307, 309 as in the prior embodiment. However, the system now includes a separate radio unit 335, 337, 339, 341 for each embedded RFID antenna 303, 305, 307, 309. Typically, each radio unit 335, 337, 339, 341 will be located within short-range communication distance (e.g., within one or two feet) of the associated consumable item 311, 313, 315, 317 and its respective embedded RFID antenna 303, 305, 307, 309.

A central device 300, which may be a mobile telecommunications device such as device 110 or otherwise, e.g., a CAN (Car Area Network) controller or the like, receives data from the separate radio unit 335, 337, 339, 341 at its RFID processor 343 and interprets the data as above to determine whether any of the consumable items 311, 313, 315, 317 has worn excessively or has failed. Subsequently, the RFID processor 343 may display or emit an alert via the user interface (UI) 345 of the monitoring device 300.

In a further embodiment, regardless of the precise monitoring architecture, a consumable item, e.g., a tire, shoe, etc., may be a movable item, and the embedded RFID antenna may therefore move with respect to a fixed antenna of a monitoring transceiver during monitoring. This case does not present any significant additional challenges so long as the embedded antenna remains within RFID range of the antenna of the monitoring transceiver, even while at the most remote point of its excursion.

Moreover, in various embodiments of the disclosed principles within this context, a system's RFID processing module may interpret the existence, movement or repetition frequency of the responsive RFID signal from the embedded antenna to indicate one or more conditions with respect to the associated consumable item. For example, nonexistence of a responsive RFID signal may indicate antenna failure, and therefore component wear or failure; speed of movement of the return signal, as gauged by a temporal change in signal strength for example, may indicate the speed of an associated item, e.g., a conveyor belt or bulldozer track; similarly, the repetition frequency of the responsive RFID signal may be used to infer an RPM of the associated component, e.g., the RPM of a car tire.

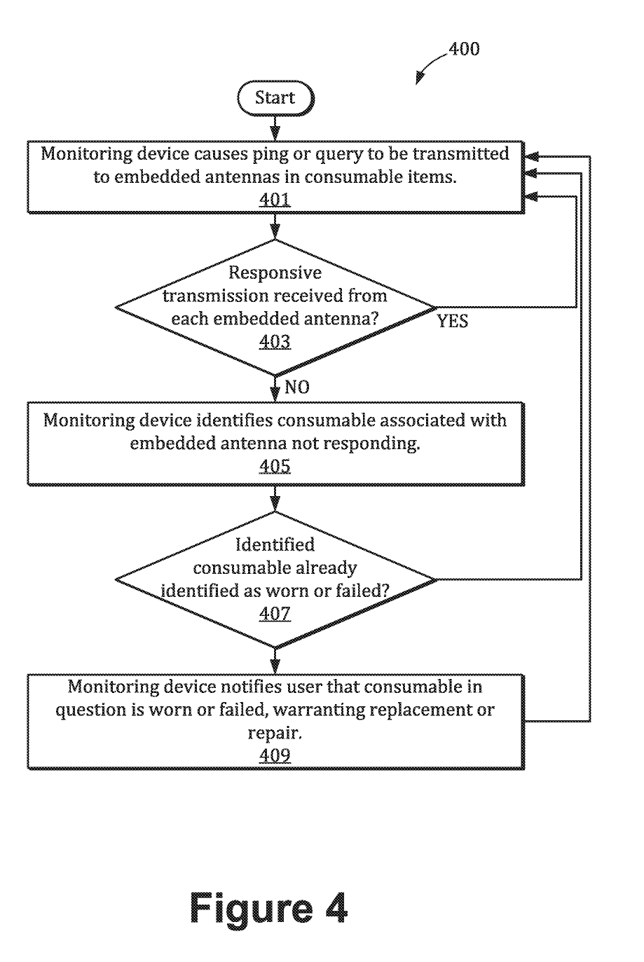

FIG. 4 is a flowchart of a process 400 for gathering and interpreting RFID data in the context of monitoring a consumable surface, e.g., of a shoe or tire, for excessive wear. The system architecture in this example may be either of those shown in FIGS. 2 and 3, or otherwise.

At stage 401 of the process 400, the monitoring device causes a ping or query to be transmitted to a plurality of embedded antennas in a corresponding plurality of consumable items, e.g., car tires that are mounted and in use or a pair of shoes worn by a user. At stage 403 of the process 400, the monitoring device determines whether a responsive transmission has been received from each embedded antenna. The antenna may be embedded in the component or surface of interest at a predetermined depth defining a predetermined wear limit, such that damage to the antenna indicates that the wear of the wearable component has extended beyond the predetermined limit.

Moreover, in order for the monitoring device to determine if a response has been received from each embedded antenna, it is helpful to be able to distinguish between responses received from different antennas. In this regard, the embedded antenna responses may be distinguished by any relevant characteristic, e.g., ID encoding, signal attenuation, differential TOF (time-of-flight) and so on.

If it is determined that responses have been received from all embedded antennas then the process 400 returns to stage 401. If it is determined that responses have not been received from all embedded antennas, then the process 400 continues to stage 405, wherein the monitoring device identifies a consumable associated with the embedded antenna from which a response was not detected. For example, the monitoring device may determine at stage 405 that one antenna signal is missing, and that the antenna associated with the missing signal is embedded in the front right tire of the car, of in the sole of the user's left shoe.

At stage 407, the monitoring device determines whether the identified consumable has already been identified as worn or failed, and if so, then the process 400 returns to stage 401. Otherwise, if the identified consumable has not yet been identified as worn or failed, the process 400 transitions to stage 409, wherein the monitoring device notifies the user (e.g., the car driver or the person wearing the shoes) that the consumable in question is worn or failed, warranting replacement or repair.

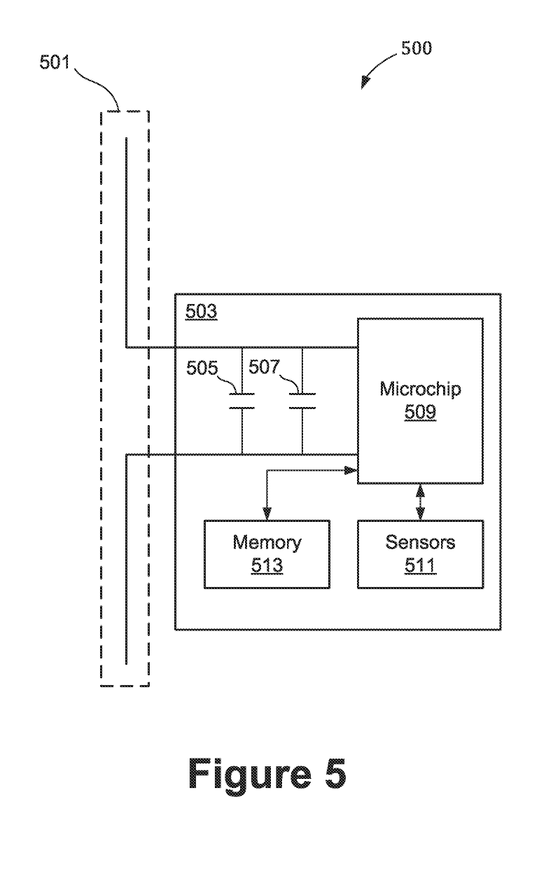

Although there are numerous different RFID antenna architectures in use, an example of one such configuration is shown in FIG. 5 for the sake of completeness. In particular, FIG. 5 is circuit diagram of a passive RFID tag antenna architecture usable in accordance with an embodiment of the disclosed principles. As can be seen, the circuit 500 includes an antenna 501 as well as a response portion 503. The response portion 503 of the circuit 500 contains one or more filtering capacitors 505, 507 as well as a microchip 509.

In addition, the circuit 500 may include one or more sensors 511 to collect and provide additional data such as motion, environment, light, moisture, and so on, to aid in decision making. Moreover, one or more memory modules 513 may be included to facilitate operation of the tag.

In operation, the receipt of an EMF signal at the antenna 501 induces a voltage in the response circuit 503. The voltage in the response circuit 503 is filtered by the one or more filtering capacitors 505, 507 before being provided to the microchip 509. The microchip 509, having been energized, emits a characteristic response for transmission by the antenna 501. In this way, the receipt of an EMF signal at the passive RFID tag causes the re-radiation of a signal that is characteristic of the particular passive RFID tag

It will be appreciated that various systems and processes for RFID-enabled wear or failure detection have been disclosed herein. However, in view of the many possible embodiments to which the principles of the present disclosure may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

We claim:

1. A method of monitoring wear of a wearable surface comprising:
emitting a near field radio frequency transmission receivable by an antenna embedded in the wearable surface, the antenna being associated with radio frequency transmission circuitry;
determining whether a responsive radio frequency transmission has been received from the antenna and associated radio frequency transmission circuitry; and
identifying the wearable surface as worn if a responsive radio frequency transmission has not been received from the antenna and associated radio frequency transmission circuitry.

2. The method in accordance with claim 1 wherein the wearable surface is a tire surface.

3. The method in accordance with claim 1 wherein the wearable surface is a shoe surface.

4. The method in accordance with claim 1 wherein the wearable surface is a belt surface.

5. The method in accordance with claim 1 wherein determining whether a responsive radio frequency transmission has been received from the antenna and associated radio frequency transmission circuitry further comprises determining whether a radio frequency ID (RFID) signal has been received from the antenna and associated radio frequency transmission circuitry.

6. The method in accordance with claim 1 wherein determining whether a responsive radio frequency transmission has been received from the antenna and associated radio frequency transmission circuitry further comprises determining that a responsive radio frequency transmission has been received and further determining that the antenna, and associated radio frequency transmission circuitry, was the source of the responsive radio frequency transmission.

7. The method in accordance with claim 1 wherein identifying the wearable surface as worn further comprises determining that the wearable surface has not previously been identified as worn.

8. The method in accordance with claim 1 wherein identifying the wearable surface as worn further comprises notifying a user associated with the wearable surface that the wearable surface is worn.

9. The method in accordance with claim 1, further comprising identifying the wearable surface as not worn if a responsive radio frequency transmission has been received from the antenna and associated radio frequency transmission circuitry.

10. A system for monitoring wear of a wearable component, the system comprising:
an antenna system embedded in the wearable component such that wear of the wearable component beyond a predetermined limit will cause damage to the antenna system, the antenna system being configured when undamaged to emit a responsive radio frequency (RF) signal when probed by an RF probe signal; and
a monitoring device comprising an RF transmitter and a processor, the processor being configured to emit an RF probe signal receivable by the antenna system, determine whether a responsive RF signal has been received from the antenna system and identify the wearable component as worn beyond the predetermined limit if a responsive RF signal has not been received from the antenna system.

11. The system in accordance with claim 10 wherein the wearable component is a tire.

12. The system in accordance with claim 10 wherein the wearable component is a shoe.

13. The system in accordance with claim 10 wherein the wearable component is a belt.

14. The system in accordance with claim 10 wherein the responsive RF signal is a radio frequency ID (RFID) signal.

15. The system in accordance with claim 10 wherein the processor is further configured to determine whether a responsive RF signal has been received by determining that an RF signal has been received and further identifying the antenna system as the source of the received RF signal.

16. The system in accordance with claim 10 wherein identifying the wearable component as worn further comprises notifying a user associated with the wearable component that the wearable component is worn.

17. The system in accordance with claim 17 wherein identifying the wearable component as worn further comprises notifying a user associated with the wearable component that the wearable surface is worn only upon a first occurrence of not receiving a responsive RF signal from the antenna system.

18. A device for monitoring wear of a wearable component having embedded therein an RFID antenna, the device comprising:
a radio frequency (RF) transceiver;
an RF antenna linked to the RF transceiver; and
a processor configured to emit an RF probe signal from the RF antenna via the RF transceiver, the RF probe signal being receivable by the embedded RFID antenna, and to determine whether the wearable component has worn beyond a predetermined limit based on whether a responsive RFID signal is received from the embedded RFID antenna.

19. The device in accordance with claim 18, wherein the processor is further configured to notify a user associated with the wearable component that the wearable component is worn if a responsive RFID signal has not been received from the embedded RFID antenna.

20. The device in accordance with claim 18, wherein the processor is further configured to determine whether a responsive RFID signal is received from the embedded RFID antenna by determining that multiple responsive RFID signals have been received and identifying a source of each responsive RFID signal.
